(19) United States
(12) Patent Application Publication
(10) Pub. No.: US 2024/0162993 A1
(43) Pub. Date: May 16, 2024

(54) SYSTEMS AND METHODS FOR WIRELESS SYSTEMS WITH MULTIPLE RADIO FRONT ENDS

(71) Applicant: Pharrowtech BV, Leuven (BE)

(72) Inventors: Khaled Khalaf, Aarschot (BE); Qixian Shi, Kessel Lo (BE); Ahmet Tekin, Leuven (BE); Guerric de Streel, Wavre (BE)

(73) Assignee: Pharrowtech BV, Leuven (BE)

(21) Appl. No.: 18/508,002

(22) Filed: Nov. 13, 2023

Related U.S. Application Data
(60) Provisional application No. 63/383,638, filed on Nov. 14, 2022.

(51) Int. Cl. H04B 17/13; H04B 1/40; H04B 17/20; H04B 17/318

(52) U.S. Cl. CPC H04B 17/13; H04B 1/40; H04B 17/202; H04B 17/318

(57) ABSTRACT

A radio transceiver includes a plurality of spatially separated radiating elements and a plurality of radio frequency front-ends, where each radiating element is associated with a radio frequency front-end of a plurality radio frequency front-ends. The radio transceiver includes a plurality of received signal sensors, where each received signal sensor is coupled to one or more radiating elements and where each received signal sensor is adapted to output a signal representative of a received signal strength for the one or more radiating elements. The radio transceiver further includes one or more processors coupled to the received signal sensors and adapted to receive the signal representative of a received signal strength from each received signal sensor and is further adapted to provide a control signal for changing a power mode for a set of radio frequency front-ends of the plurality radio frequency front-ends based on the received signal strength signal.

### CROSS-REFERENCE TO RELATED APPLICATIONS

The present U.S. Utility patent application claims priority pursuant to 35 U.S.C. § 119(e) to U.S. Provisional Application No. 63/383,638, entitled “RADIO SYSTEM FOR A MOBILE VIRTUAL AND ASSISTED REALITY APPARATUS”, filed Nov. 14, 2022, which is hereby incorporated herein by reference in its entirety and made part of the present U.S. Utility patent Application for all purposes.

### TECHNICAL FIELD OF THE INVENTION

This invention relates generally to wireless technology and more particularly to millimeter wave (mmWave) radio technology.

### DESCRIPTION OF RELATED ART

Data communication involves sending data from one device to another device via a communication medium (e.g., a wire, a trace, a twisted pair cable, a coaxial cable, air/wireless, etc.). The devices range from dies within an integrated circuit (IC), to ICs on a printed circuit board (PCB), to PCBs within a computer, to computers, to networks of computers, and so on.

Data is communicated via a wired and/or a wireless connection and is done so in accordance with a data communication protocol. Data communication protocols dictate how the data is to be formatted, encoded/decoded, transmitted, and received. For some data communications, digital data is modulated with an analog carrier signal and transmitted/received via a modulated radio frequency (RF) signal.

Wireless technologies based on relatively high radio frequencies have proven capable of delivering data transmissions in the range of multi-gigabits/second with relatively lower latency. In general, multi-gigabit/second communication speeds require relatively wide transmission bandwidths, which are available with high carrier frequency wireless communication systems; these include frequencies in the millimeter wave (mmWave) range (i.e., 30-300 GHz). For example, the IEEE 802.11ad wireless networking standard enables the transmission of data at high data rates up to multiple gigabits per second, enabling transmission of uncompressed UHD video over a wireless network.

Wireless communication systems designed for use in the mmWave range benefit from high levels of integration, allowing for manufacturing efficiencies that can lead to lower cost, shorter manufacturing periods and higher performance. As is further known, millimeter-wave radio signals are propagated solely by line-of-sight paths. Moreover, millimeter waves can exhibit optical-like propagation characteristics and can therefore be reflected and focused by small metal surfaces and dielectric lenses.

### BRIEF DESCRIPTION OF THE SEVERAL VIEWS OF THE DRAWING(S)

FIG. 1A provides an illustration of a dynamically mobile virtual reality (VR) device, in accordance with the present invention;

FIG. 1B provides an illustration of an Inertial Measurement Unit (IMU) in accordance with various aspects described herein;

FIG. 1C provides an illustration of a use environment for a dynamically mobile virtual reality (VR) device, in accordance with the present invention;

FIG. 1D provides an illustration of a dynamically mobile virtual reality (VR) device with multiple mmWave antennas, in accordance with the present invention;

FIGS. 1E, 1F & 1G provide illustrations of a dynamically mobile device with multiple mmWave antennas, in accordance with the present invention;

FIG. 2A provides an illustration of a dynamically mobile mmWave antenna array, in accordance with the present invention;

FIG. 2B provides another illustration of antennas in a two-dimensional antenna array, in accordance with the present invention;

FIG. 2C provides a two-dimensional antenna array illustrating movement, in accordance with the present invention;

FIG. 2D provides another two-dimensional antenna array illustrating movement, in accordance with the present invention;

FIG. 2E provides another two-dimensional antenna array illustrating movement, in accordance with the present invention;

FIG. 3A provides a schematic representation of a wireless communication system with multiple selectable radio front ends, in accordance with the present invention;

FIG. 3B provides another schematic representation of a wireless communication system with multiple selectable radio front ends, in accordance with the present invention;

FIG. 3C provides another schematic representation of a wireless communication system with multiple selectable radio front ends, in accordance with the present invention;

FIG. 3D provides another schematic representation of a wireless communication system with multiple selectable radio front ends, in accordance with the present invention;

FIG. 4A illustrates a representative radio signal and signal envelope;

FIG. 4B provides a schematic of an envelope detector for radio signals using an FFT processor, in accordance with the present invention;

FIG. 4C provides a schematic of a peak detector for radio signals, in accordance with the present invention;

FIG. 4D provides a schematic of a power detector for radio signals, in accordance with the present invention;

FIG. 5A provides an illustration of another use environment for a dynamically mobile virtual reality (VR) device, in accordance with the present invention;

FIG. 5B provides an illustration of a multi-user environment for dynamically mobile virtual reality (VR) devices, in accordance with the present invention;

FIG. 6A is a logic diagram of an example method for implementing a wireless communication system for a dynamically mobile virtual reality (VR) device, in accordance with the present invention;

FIG. 6B is a logic diagram of an example method for implementing a wireless communication system for a plurality of dynamically mobile virtual reality (VR) devices, in accordance with the present invention;

FIG. 7A provides a schematic block diagram of a wireless transceiver utilizing a waveguide, in accordance with the present invention;

FIG. 7B provides a schematic block diagram of another wireless transceiver utilizing a waveguide structure, in accordance with the present invention;

FIG. 8A provides a medial view diagram of a wireless transceiver utilizing a waveguide structure, in accordance with the present invention;

FIG. 8B provides top-down view diagram of a wireless transceiver utilizing a waveguide structure in a radio transceiver, in accordance with the present invention;

FIG. 8C provides medial view diagram of a wireless transceiver waveguide structure utilizing a waveguide, in accordance with the present invention;

FIG. 9A provides top-down view diagram of a wireless transceiver utilizing a waveguide structure implemented with a splitter, in accordance with the present invention;

FIG. 9B provides a medial view diagram of a wireless transceiver utilizing a waveguide structure implemented with a splitter, in accordance with the present invention;

FIG. 10 provides a medial view diagram of a wireless transceiver utilizing a waveguide structure, in accordance with the present invention;

FIG. 11A provides a medial view illustration of a dynamically mobile virtual reality (VR) device implemented using flexible waveguides, in accordance with the present invention;

FIG. 11B provides a medial view diagram of a dielectric flex waveguide structure, in accordance with the present invention; and

FIG. 11C provides a perspective view illustration of a dynamically mobile virtual reality (VR) device implemented using flexible waveguides, in accordance with the present invention;

### DETAILED DESCRIPTION OF THE INVENTION

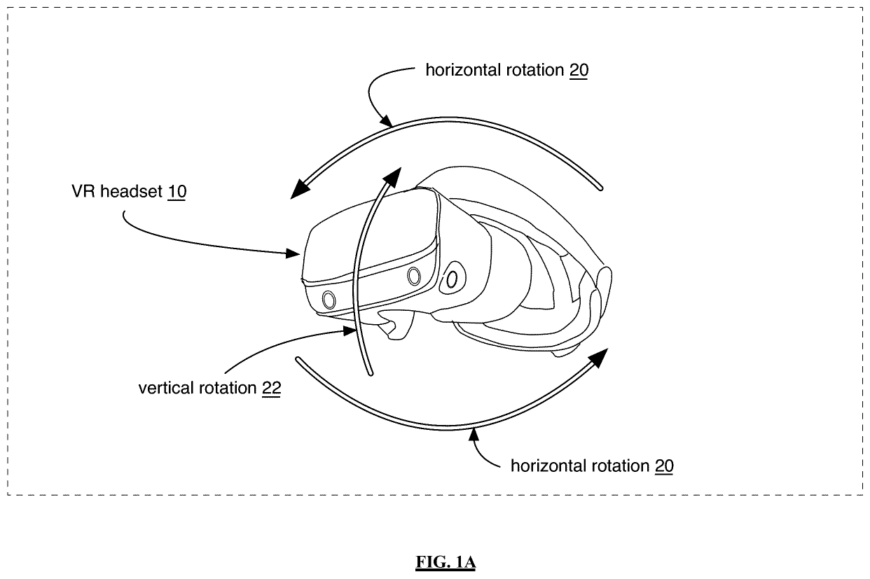

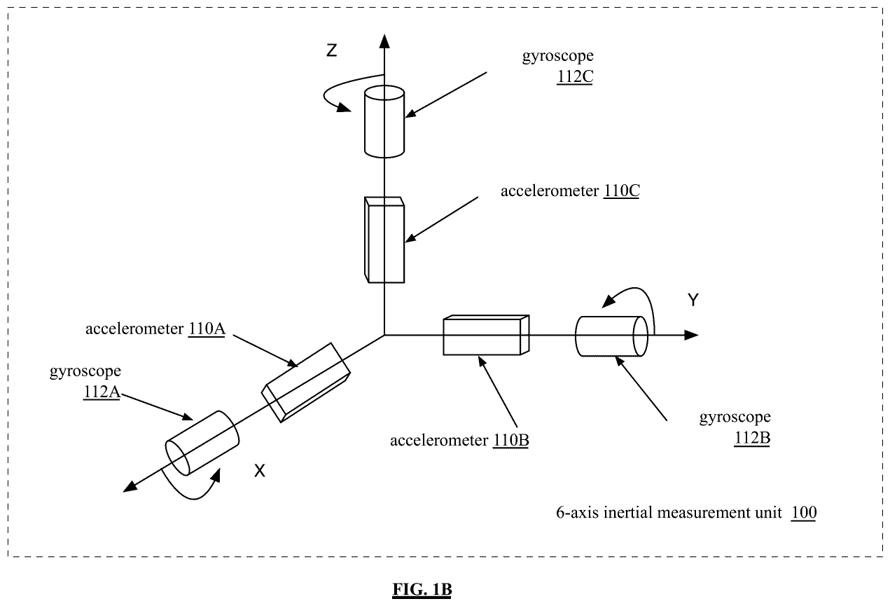

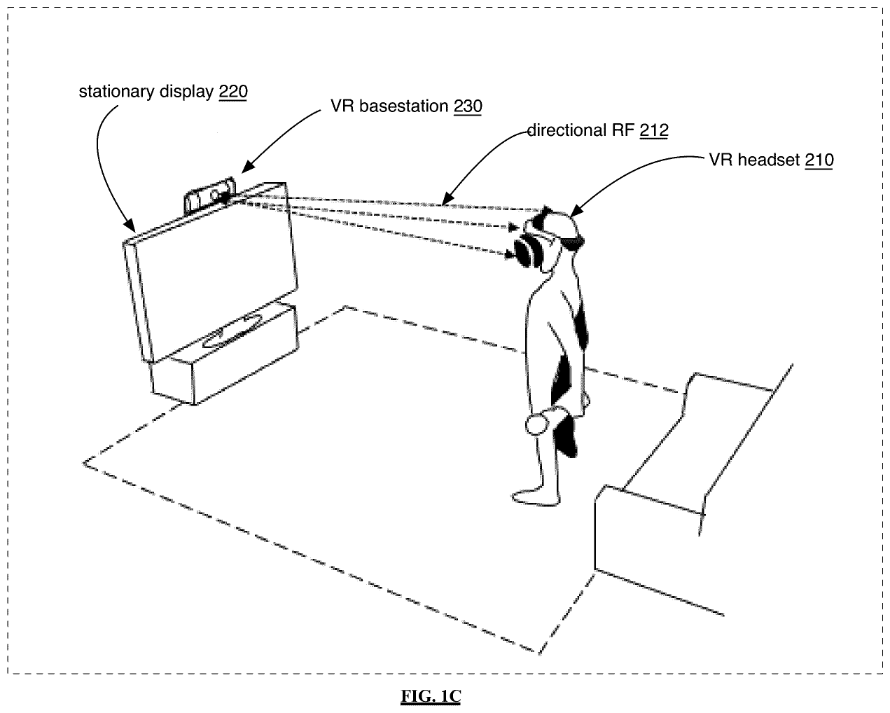

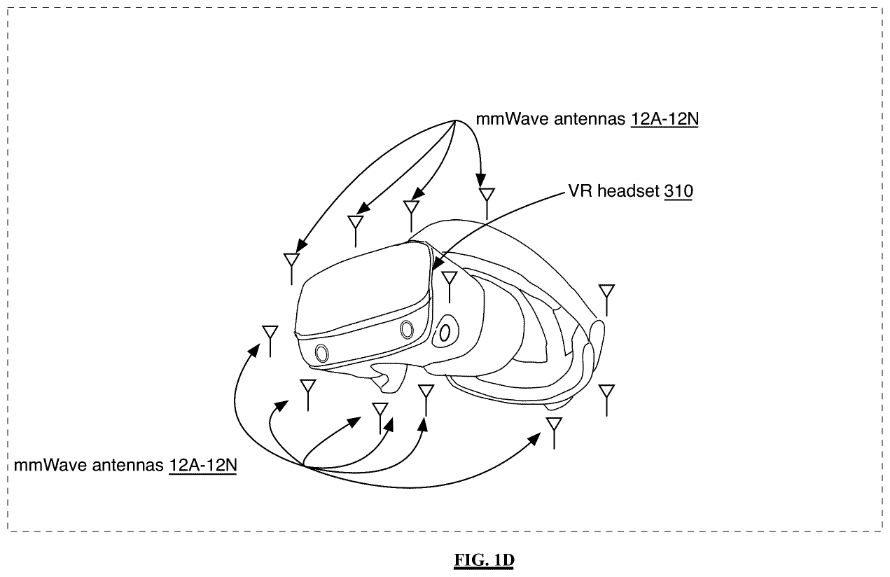

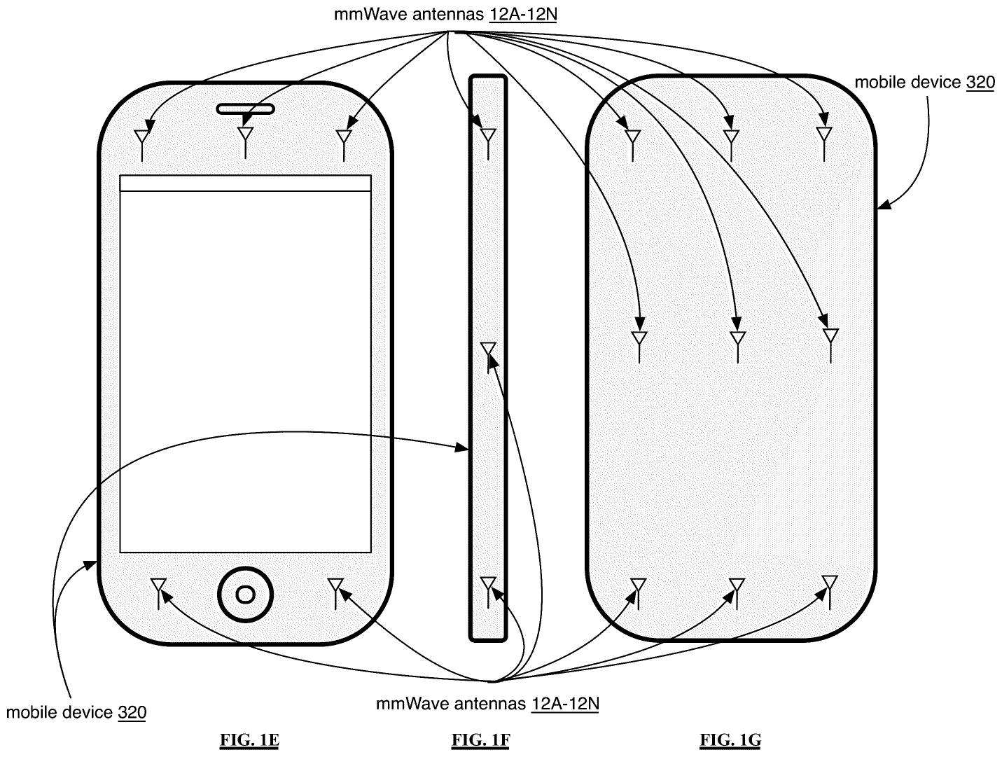

FIG. 1A provides an illustration of a dynamically mobile virtual reality (VR) device with a head-mounted display (VR headset). VR and assisted reality (AR) implementations and applications can require dynamic tracking of a user's head. In an example, a software application can request the head orientation of a user, with a processor providing a scene for each eye. In an illustrative example, when frame rate for the display to each eye of a VR headset is maintained, the experience can appear real and enjoyable. When frame rate changes do not happen in time, a previous frame can persist, which can be disorienting. Accordingly, while display resolution for VR and AR implementations increase and software applications demand lower latency response to movement, there is a persistent need for high bandwidth wireless communication to and from VR headsets and AR devices. Communication between VR headsets and AR devices can be implemented according to a variety of communication options, including proprietary mechanisms and standardized communication systems, such as various Wireless LAN (802.11) standards.

In an example, a VR headset 10 is able to move in multiple directions, including up, down, forward and backward, while also rotating, thereby experiencing various combinations of rotation, illustrated here as horizontal rotation 20 and vertical rotation 22. Accordingly, a VR headset user can be adapted to collect and transmit movement reflecting nearly unlimited coordinates and vectors that can be used for VR functions. In a related example, an AR device can be used instead of a VR device, where an AR device is adapted for use in a real-world setting while VR device is adapted for a virtual setting. In an example, AR users can be described as being able to control their presence in the real world, whereas VR users are controlled by a system.

FIG. 1B provides an illustration of an Inertial Measurement Unit (IMU) for a 3 Cartesian coordinate axis for collecting movement associated with movement of, for example, the virtual reality (VR) device of FIG. 1A. In an example of operation and implementation, a built-in inertial measurement unit (IMU) can be used to capture a VR device user's head motion. In an example, an inclination sensor (not shown) can detect a level angle in two directions, wherein a change in level angle or “inclination” of an item, such as VR headset 10 can be sensed and converted to an electrical signal. In the example, rotation about an axis X of an inclination sensor (between X− and X+) and/or rotation about an axis Y of inclination sensor (between Y− and Y+) can be measured such that level angle is known in 2-axes.

In another example, an accelerometer can measure the rate of change of velocity of an object, such as VR headset 10, in relation to 3 Cartesian coordinate axes (X, Y and Z). In the example, a 3-axis accelerometer (accelerometers 110A, 110B and 110C in Cartesian coordinate axes X, Y and Z, respectively), can be adapted to measure acceleration in three axes that are linked to each other, such that the reference for acceleration applied to an object coupled to the 3-axis accelerometer can be known relative to the object itself. In the example of an object coupled to a 3-axis accelerometer placed at the center of a system, adjusting one of its axes to the rotation of the object would not enable the 3-axis accelerometer to detect changes in the rotational speed of the object. Accordingly, a 3-axis accelerometer cannot be used to measure a change in position of an object; thus if the object is rotated, the orientation of the 3 axes would change without registering a change in position as the object is rotated.

In another example of implementation and operation, the 6-axis Inertial Measurement Unit (IMU) illustrated in FIG. 1B can comprise gyroscopes and accelerometers, such as the accelerometers described above. A gyroscope is a sensor that can measure the angular rate of an object's motion. In the example of 6-axis inertial measurement unit (IMU) 100, gyroscopes (120A, 120B and 120C) and accelerometers 110A, 110B and 110C are provided in each of an X, Y and Z axis. Together, these sensors provide 6 component motion sensing: accelerometers for X, Y and Z movement, and gyroscopes for measuring the extent and rate of rotation in space. In a specific example, a 6-axis IMU can also provide measuring stability by considering the movements caused by vibrations. At any one moment in time, either the gyroscope or accelerometer can be independently turned off to provide a lower power operating state.

In an additional example, the 6-axis inertial measurement unit 100, can include a magnetometer (not shown) in each of an X, Y and Z axis. In the example, a magnetometer is a device that measures magnetic field or magnetic dipole moment. A magnetometer (such as a compass) can be used to measure the direction, strength, or relative change of a magnetic field at a particular location. In the example of a compass, a magnetometer can be adapted to record the effect of a magnetic dipole on the induced current in a coil. As is relevant to various examples herein, a magnetometer can be used to provide absolute angular measurements relative to the Earth's magnetic field. In an example, as with the 6-axis IMU 100, each of the sensors, i.e. any of the three accelerometers, three gyroscopes or three magnetometers can be enabled or disabled for a lower power operating state.

In an example of implementation and operation, a 6-axis IMU with magnetometers can be coupled to a moveable object, such as VR headset 10 referring to FIG. 1A, or augmented reality (AR) glasses, enabling the sensing/measurement of a rate of change of velocity of the VR headset 10, an angular rate of VR headset 10's motion and the absolute angular measurements relative to the Earth's magnetic field for VR headset 10.

FIG. 1C provides an illustration of a use environment for a dynamically mobile virtual reality (VR) device. In the example referring to FIG. 1A, VR headset 210 is worn by a user in a system incorporating a feedback device, such as a display in VR headset 210, stationary display 220 and a base station, such as VR base station 230. In an example, the user's movements can be measured and transmitted to VR base station 230 using one or more wireless transceivers adapted to provide wireless communication, between VR base station 230 and VR headset 210. In an example, the wireless communication can provided using high speed directional radio transmission, such as directional RF 212 and processed for display and/or for interaction with an application executed on a processor associated with VR headset 210. In an example, the application can be any of an exercise application, an augmented reality (AR) application, or any other interaction-based application that relies on feedback relative to movement. Additionally, in an example, VR headset 210 can be adapted for use with additional devices that can also be tracked and used by an application for feedback and/or other application related uses.

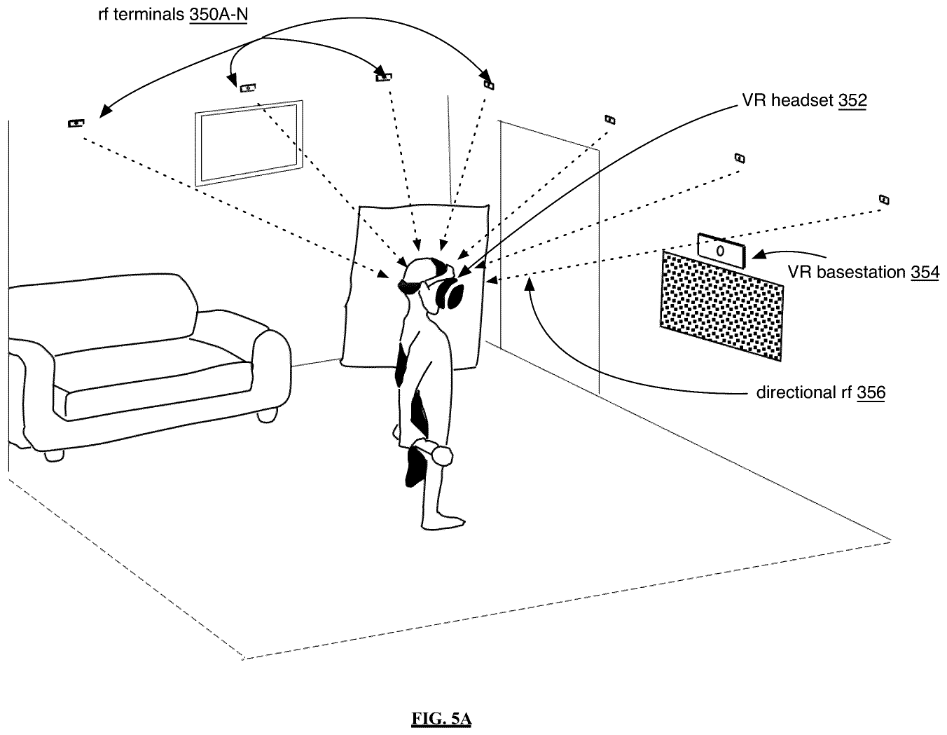

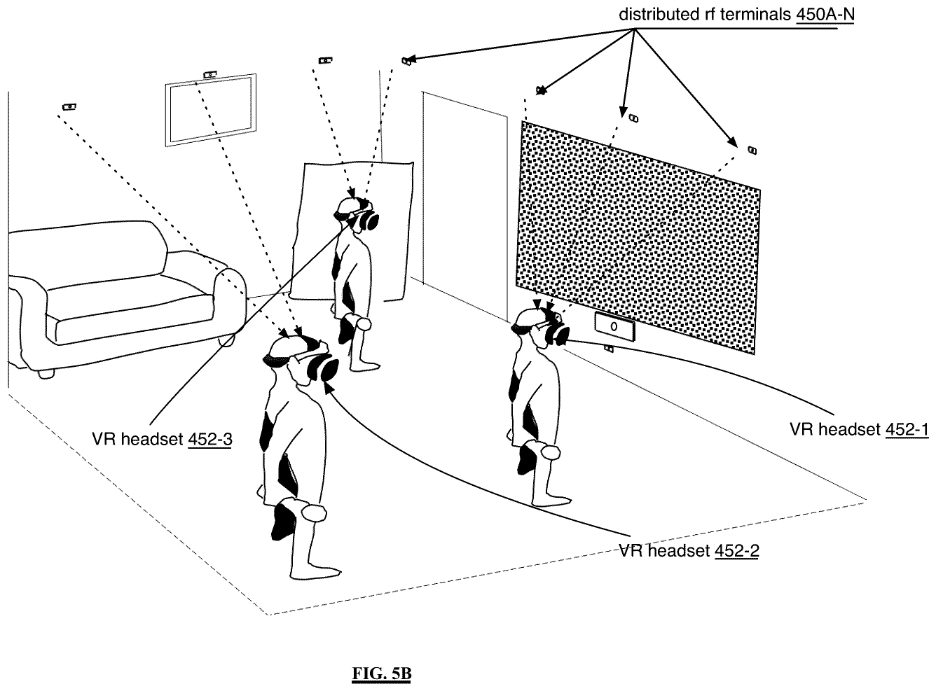

FIG. 1D provides an illustration of a dynamically mobile virtual reality (VR) device with multiple millimeter wave (mmWave) antenna locations. In the example, VR headset 310 can be adapted to include spatially separated mmWave antennas, such as mmWave antennas 12A-12N, to provide a substantially clear line of sight between at least one mmWave antenna of a group of mmWave antennas and a stationary antenna or antennas associated with a base station, such as VR base station 230 referring to FIG. 1C. In a related example further illustrated in FIG. 5A, multiple stationary antennas can be implemented to provide line-of-sight access to one or more mmWave antennas on VR headset 310.

FIGS. 1E, 1F & 1G provide front, side and rear views of a dynamically mobile device provisioned with multiple mmWave antenna locations. In an example, mobile device 320 can be adapted to include spatially separated mmWave antennas, such as mmWave antennas 12A-12N, around its outside periphery to provide a substantially clear line of sight between at least one mmWave antenna of a group of mmWave antennas and a stationary antenna or antennas associated with an access point, such as the VR base station 230 referring to FIG. 1C. In a related example, further illustrated in-part in FIG. 5A, multiple stationary antennas can be implemented to provide line-of-sight access to one or more mmWave antennas on mobile device 320.

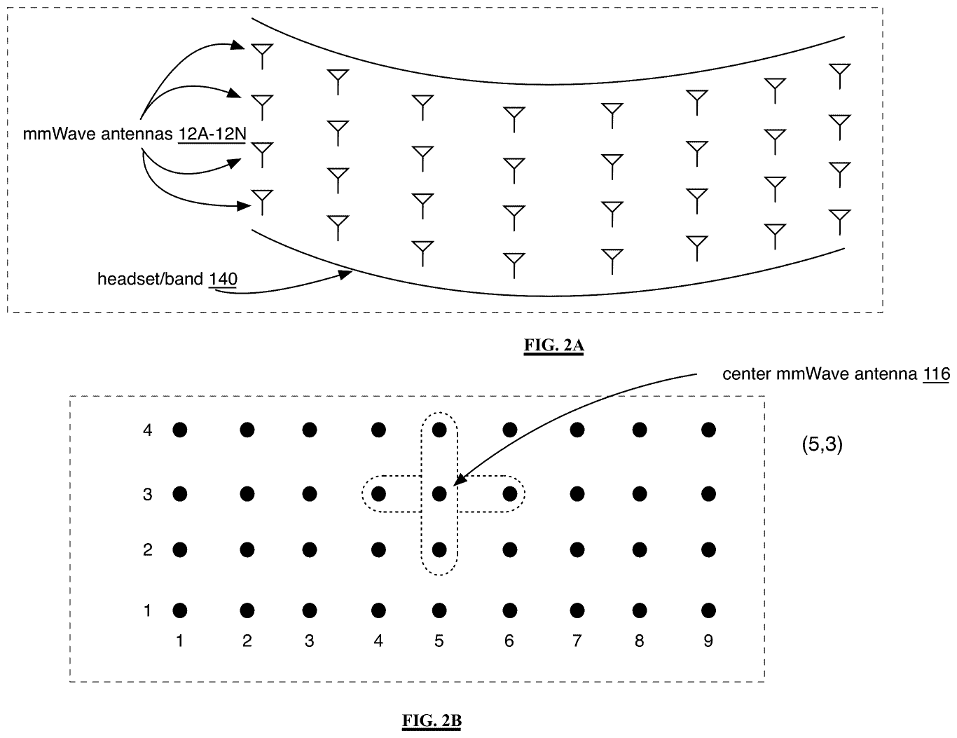

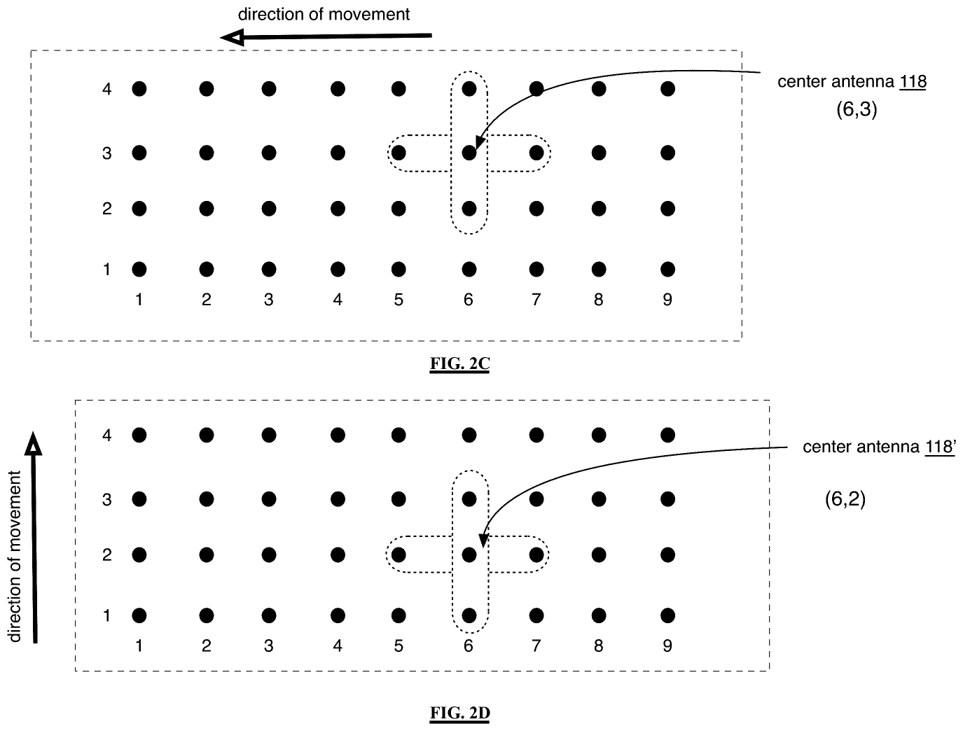

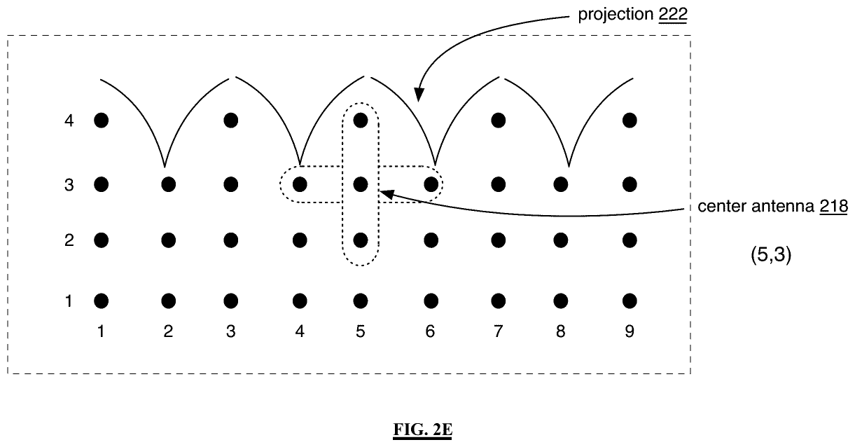

FIG. 2A provides an illustration of an antenna array for incorporation in a dynamically mobile virtual reality (VR) device. In the example, mmWave antennas 12A-12N are adapted for implementation on a headset or headband (headset/band 140) so that mmWave antennas 12A-12N are spatially separated in the columns and rows of a two-dimensional matrix. In an example, mmWave antennas 12A-12N can be implemented on a curved surface, such as around the circumference of a VR headset, including, for example, VR headset 310 from FIG. 1D, or around a portion of the surface a user's head (for example using a rigid headband, a flexible headband, the side panels of a baseball cap and/or modified temples for AR glasses). In the example, mmWave antennas 12A-12N can be adapted for use on any flexible surface that can be implemented on a curved surface.

FIG. 2B provides an illustration highlighting select mmWave antennas in a two-dimensional mmWave antenna array. In an example, a center mmWave antenna 116 is illustrated in a matrix of mmWave antennas implemented according to FIG. 2A, such that center mmWave antenna 116 can be selected for transmission to, for example, VR base station 230, referring again to FIG. 1C.

FIG. 2C provides an illustration highlighting select mmWave antennas in a two-dimensional mmWave antenna array. In an example, a center mmWave antenna 118 is illustrated in a matrix of mmWave antennas implemented according to FIG. 2A, along with neighboring mmWave antennas, to accommodate direction of movement of a headset/band (such as headset/band 140 referring to FIG. 2A) in a left to right (X) direction, where movement in an X direction can result in a change of center mmWave antenna 118 along row 3 as needed to provide for clear line-of-sight to, for example, a VR base station, such as VR base station 310 of FIG. 1D, for example.

FIG. 2D provides an illustration highlighting selections of mmWave antennas in a two-dimensional mmWave antenna array based on movement. In an example, a center mmWave antenna 118′ is illustrated in a matrix of mmWave antennas implemented according to FIGS. 2A and 2B, along with neighboring mmWave antennas, reflecting a change in the center mmWave antenna 118 (referring to FIG. 2C) accommodate direction of movement of a headset/band 140 from FIG. 2A in a up and down (Y) direction, where movement in an Y direction can result in a change of center mmWave antenna 118 along column 6 as needed to provide for clear line-of-sight to, for example, a VR base station, such as VR base station 310 of FIG. 1D.

FIG. 2E provides another illustration highlighting selection of mmWave antennas in a projected two-dimensional mmWave antenna array. In an example, a group of mmWave antennas can be implemented with an array or semi-array that can be adapted to determine a predicted line of sight determination (projection) for movement in one or more directions. In another example, the center mmWave antenna 218 can be determined based on a projection 222 of movement of a user relative to a headset/band 140, referring again to FIG. 2A.

In an example of implementation, the headset/band 140 of FIG. 2A can be curved in both an X, Y and Z direction, such that one or more rows of mmWave antennas at the top of headset/band 140 (in the Y direction) are closer relative to each other to accommodate a reduced circumference of the array surface at the top of headset/band 140. In an example, a number of mmWave antennas required at the top of the array to retain clear line of sight with a VR base station such as VR base station 310, can be reduced.

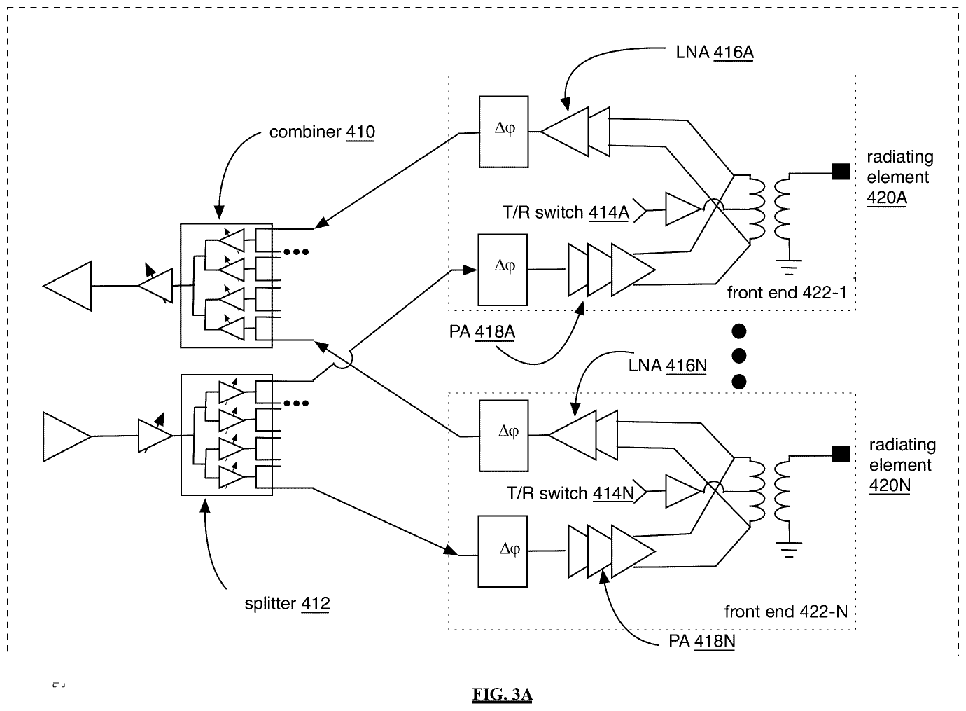

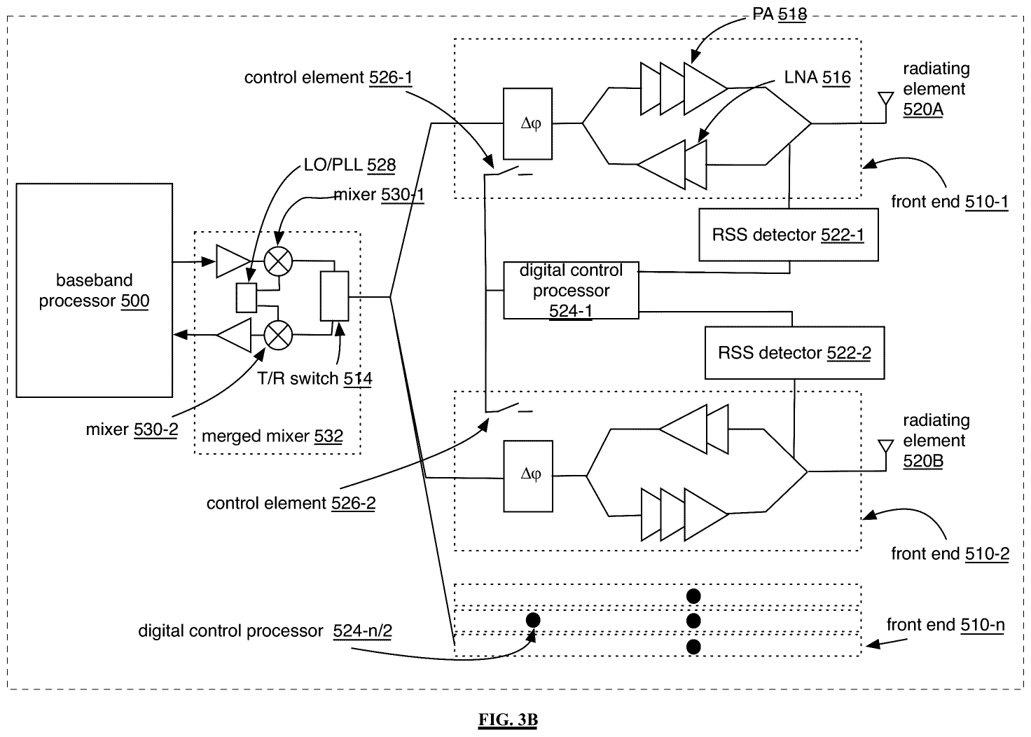

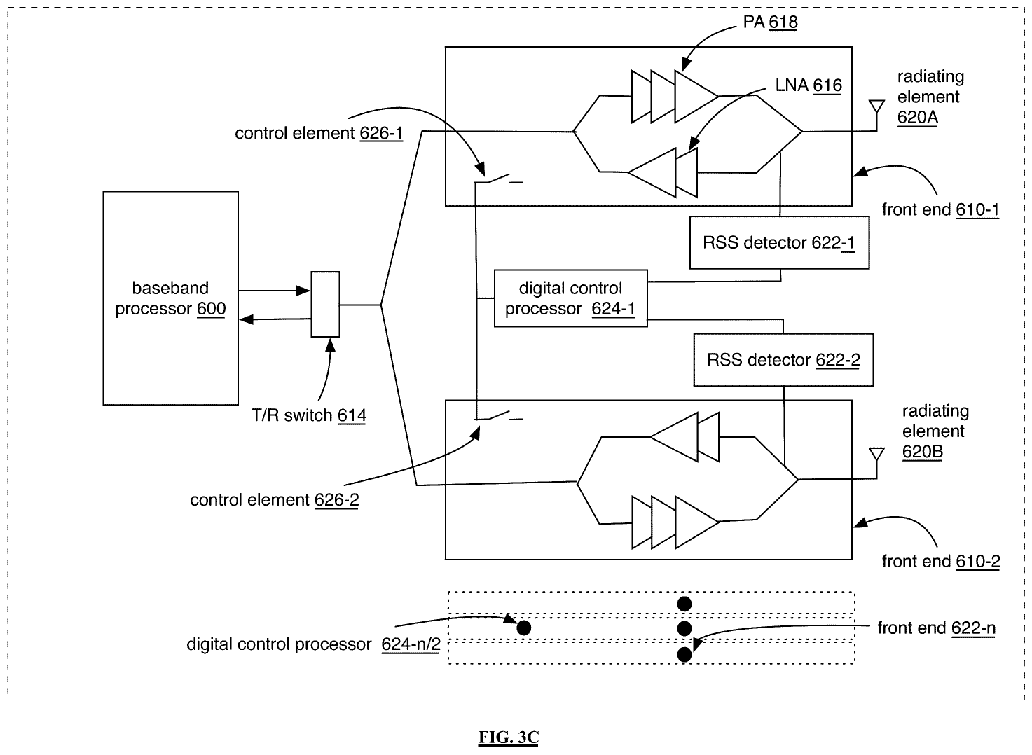

FIG. 3A provides a schematic representation of a wireless communication system architecture with multiple selectable radio front ends. In an example, a plurality of mmWave radio front ends 422-1-422-N can be implemented in a wireless communication system and combined using a combiner and or splitter, such as combiner 410 and splitter 412 for receive/transmit functions. In the example, each antenna front end can be configured with a transmit/receive switch, such as T/R switch 414A-414N, along with a low noise amplification LNA, such as LNA 416A-414N and a power amplifier, such as PA 418A-418N.

In an example, each antenna front end of the plurality of mmWave radio front ends 422-1-422-N can include 1-n radiating elements, such as radiating elements 420A-420N. In an example of implementation, each of radiating elements 420A-420N can be an antenna patch, such as a planar antenna, where the patch is a flat, printed antenna that can be, for example, etched onto a dielectric substrate. In various examples, antenna patches can be configured in various shapes and designs. In an example of implementation, an antenna patch can be adapted to provide compact size, ease of integration with semiconductor technologies and the capability of supporting high-frequency operations. Example antenna patch types can include: 1) microstrip patch antennas (comprising a metal patch on one side of a dielectric substrate and a ground plane on an opposing side); 2) slot antennas (comprising a slot or opening in a metal surface); 3) patch array antennas (comprising multiple patch antennas used, for example, to steer the direction of a beam electronically in a phased array application; and 4) dielectric resonator antennas (comprising a dielectric resonator mounted on a ground plane.

In various examples of operation and implementation, the specific design and characteristics of radiating elements 420A-420N can be based on factors such as beamwidth, gain, and radiation pattern and can, for example, be further adapted to accommodate one or more of frequency, polarization, and desired performance.

FIG. 3B provides another schematic representation of a wireless communication system with multiple selectable radio front ends. In the example, a received signal strength detector, such as RSS detector 522-1, 522-2-522-n, can be associated with each of radio front end 510-1, 510-2-510-n in a system incorporating multiple radio front ends. In an example of implementation, a processor, such as digital control processor 524-1 can be adapted to manage radio transmission to and from a pair of radio front ends, such as 510-1 and 510-2-510-n. In an example, digital control processor 524-1 can be coupled to a switch, such as control element 526-1 and 526-2 for a pair of radio front ends 526-1 and 526-2. In some examples, digital control processor 524-1 can be coupled to RSS detectors 522-1 and 522-2 and adapted to control the operation of radio front ends 526-1 and 526-2 based on a current measured radio signal strength from radiating elements 520A and 520B, respectively. In a related example, a digital control processor can be provided for each pair of radio front ends 526-1 and 526-2, such that the total of digital control processor is equal to the number of radio front ends in a wireless communication system divided by two.

In an example of implementation, radio front ends 510-1, 510-2-510-n can be implemented in a wireless communication system using a merged mixer 530, where the merged mixer 530 comprises LO/PLL 528, T/R switch 514, transmit mixer 530-1 and receive mixer 530-2 to provide the input/output for radio front ends 510-1-510-n to baseband processor 500.

In various examples, determining a receive signal strength for a plurality of radio front ends, such as the radio front ends associated with the antenna arrays illustrated in FIGS. 2A-2E, can be implemented on a continuous basis for all of the plurality of radio front ends. In other examples, each radio front end can be monitored on a noncontinuous basis using one or more determinative techniques. In a specific related example of implementation and operation of a multi-radio front end system, received signal strength for each radio front end of the multiple radio front ends can be adapted for monitoring based on a duty cycle, where a duty cycle (%) is expressed as:

D=PW/T*100%

In another example the duty cycle can be expressed as a ratio where:

D=PW/T

In examples incorporating duty cycles, D is the duty cycle, PW is the pulse width (pulse active time) for monitoring received signal strength and T is the total time window for the signal. Thus, a 60% duty cycle means the signal is on 60% of the time but off 40% of the time. The “on time” for a 60% duty cycle could be a fraction of a second or more, depending on the length of the period. In an alternative example, the monitoring of received signal strength for a given radio front end can be triggered based on an external signal. In yet another example, a radio front end of a plurality can be monitored based on proximity to a current center antenna, such as center antenna 218 (referring to FIG. 2E). In a related example, a radio front end of a plurality can be monitored based on projected motion of an array, or in another example, a combination of proximity to a current center antenna and projected motion.

FIG. 3C provides a schematic representation of a direct conversion wireless communication system architecture with multiple selectable radio front ends. In an example of implementation, a wireless communication system can share much of the architecture of the systems of FIGS. 3A and 3B, while eliminating the need for some elements by using a direct conversion radio architecture. In an example of implementation, received signal strength detectors (RSS) detectors 622-1 and 622-2 can be a coupled to radio front ends 610-1 and 610-2, respectively and to digital control processor 624-1, while eliminating the need for an intermediate frequency amplifier and/or filter for some or all radio front ends. In an example, a wireless communication system based on direct conversion can be implemented with a digital control block (digital control processor) shared between two radio front ends, with a single mixer required (instead of the two mixers required in, for example, the systems of FIGS. 3A and 3B). Control elements 626-1 and 626-2 (along with control element 626-n, not shown) are illustrated as switches. In various examples of implementation, each of control elements 626-1-626-n can also be implemented as a voltage controlled variable gain circuit, a variable bias circuit or other structures. In a related example, the switch can be gated to a ground element for the radio front end. (Note—similar language or a reference needed for 3A, 3B and 3D)

As in other examples, each of radiating elements 620A and 620B (along with 622N, not shown) can be an antenna patch, such as a planar antenna, or other antenna types, configured in various shapes and designs, where the specific design and characteristics of radiating elements 620A-620N can be based on factors such as beamwidth, gain, and radiation pattern and can, for example, be further adapted to accommodate one or more of frequency, polarization, and desired performance. In an example, transmit receive (T/R) switch 614 can be implemented with a down conversions and/or up conversion element to accommodate and/or reduce the operational constraints of baseband processor 600. In yet another example of implementation, transmit receive (T/R) switch 614 can be implemented without additional elements, such as the merged mixer 532 and amplifiers illustrated in FIG. 3B.

FIG. 3D provides a schematic representation of another wireless communication system architecture with multiple selectable radio front ends. In an example of implementation and operation, a plurality of radio front ends FE 710-1 to 710-n can be implemented with a common digital control block, such as digital control processor 724. In an example, each of RSS detectors 722-1 to 722-n are coupled to a radiating element associated with one of radio front ends FE 710-1 to 710-n and coupled to digital control processor 724. In an. Alternative example, a single example, a single connection can be provided to digital control processor 724 for radio front ends FE 710-1 to 710-n, with the radio signal strength indication for each radio front end multiplexed on the single connector. In an example, a single analog to digital converter (ADC) can be provided for the single connector implementation, with the ADC then coupled to digital control processor 724. In the example of FIG. 3D, the antenna for each of radio front ends FE 710-1 to 710-n can be implemented with a variety of antenna types, including any of the patch antenna implementations described above.

In an example of implementation, a single T/R switch 714 can be coupled to baseband processor 700 for providing receive and transmit signals from/to each of radio front ends FE 710-1 to 710-n.

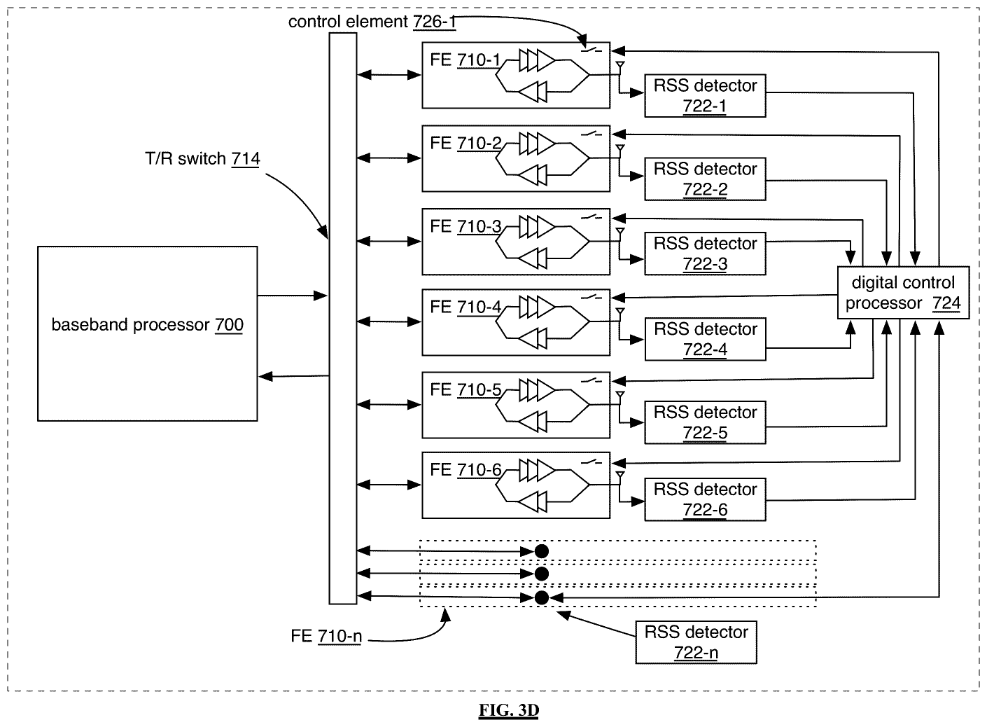

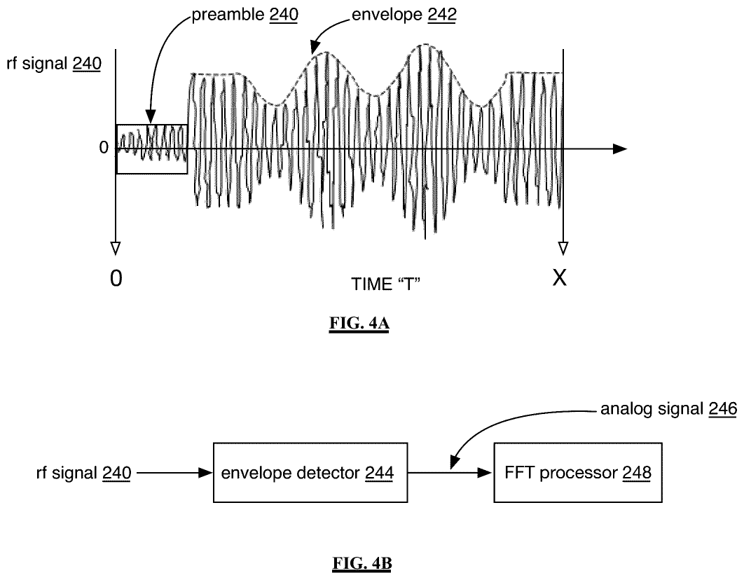

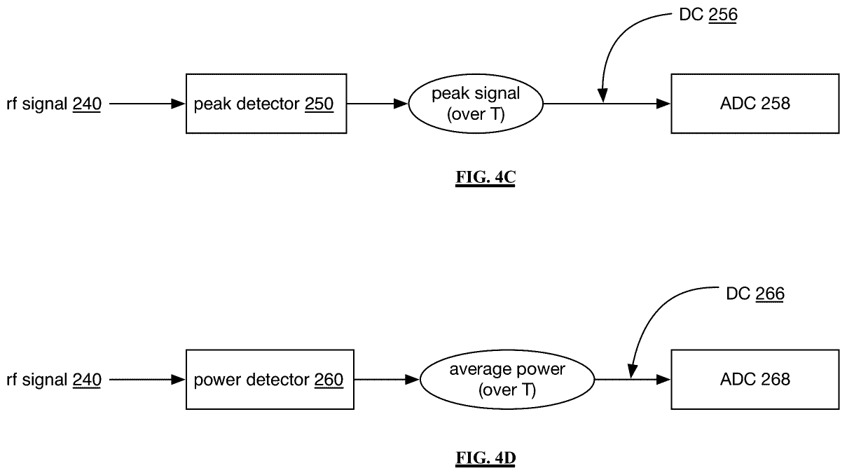

FIG. 4A illustrates a representative envelope for a radio signal. An incoming radio signal to a radio transceiver can be in the form of an amplitude-modulated (AM) signal, where transmitted information is encoded in the amplitude (envelope) of the carrier signal. In an example, an envelope detector can be used to extract the envelope 242, where the envelope detector is adapted to rectify the incoming signal and smooth it, in order to determine the varying amplitude of the carrier signal. As illustrated in FIG. 4A, a received radio (if) signal 240 over time period 0-X includes a preamble 240, followed by the envelope 242.

FIG. 4B illustrates an envelope detector configured with a Fast Fourier transform (FFT). In an example, a continuous analog signal from an envelope detector can be converted into a digital format to analyze the frequency components of the received signal. In a related example, a received signal strength for the analog signal, can be determined by sampling the analog signal at a rate high enough to accurately represent the envelope. In the example of FIG. 4B, the analog product (analog signal 246) of a radio signal 240 through envelope detector 244 is processed by Fast Fourier (FFT) processor 248 to determine a received signal strength for a radio front end. In a further example, before applying an FFT to the analog signal, an envelope detector can be configured to apply a window function to the sampled data, where the window function can be used to attenuate spectral leakage and/or augment specific portions of the signal in the time domain. In several examples, the choice of a window function, from a variety of window function options, can affect the accuracy and/or usefulness of the FFT results.

In an example of implementation and operation, a Fast Fourier Transform (FFT) can be applied to an analog signal, such as the analog signal of FIG. 4B, where the FFT can be described as a mathematical technique adapted to decompose a time-domain signal into frequency components. In the example, the result of the FFT function is a complex spectrum that indicates how the signal's energy is distributed across different frequencies. In the example of FIG. 4B, the FFT can provide information about the frequency content of the signal, and the magnitude of the FFT output at a specific frequency can be indicative of the signal strength at that frequency.

In an example, a specific frequency or frequency range can be selected based on the FFT result in the context of measuring received signal strength, for example selecting the frequency of the received signal. In a related example, the magnitude of the FFT result at the chosen frequency or frequency range represents the received signal strength, as, for example, as the signal's power or magnitude in the frequency domain.

In an example of implementation and operation, an envelope detector can be configured to generate an analog signal for use at an analog to digital converter (ADC). In an example, the ADC can be configured for fast sampling, with the digital output being further processed in the digital domain. An example fast sampling ADC could be adapted to provide a sampling rate equal to or higher than 2× the envelope frequency. Digital processing examples include Fast Fourier Transform (FFT) operations, complex functions, etc.

FIG. 4C illustrates a peak detector for radio signals. In an example, peak detector 250 is configured to receive rf signal 240 and can be further configured to generate DC signal 256 for input to ADC 258. In a specific example, peak detector 250 can be configured to provide a relatively slow-moving DC signal, where the rate of change is limited by a convergence time that thereby contributes to a calibration time, with a resultant low data-rate overhead. In an example, a slow-moving DC signal reduces resolution and accuracy requirements for the ADC. In an example, output from the ADC can be stored in a digital register configured to provide a digital read without the need for additional digital processing. In an example, a peak detector, such as the peak detector illustrated in FIG. 4C, operates best in an ideal environment, because the performance of the peak detector can suffer from impedance changes due to reflections in a given setting.

FIG. 4D illustrates a power detector for radio signals. In an example, power detector 260 is configured to receive rf signal 240 and can be further configured to generate DC signal 266 for input to ADC 268. A power detector, such as power detector 260, can provide a DC signal that represents the signal strength similar to a peak detector, however the power detector can be configured to be less susceptible to impedance variations than a peak detector would be. In various examples, antenna manufacturing processes and other anomalies can result in impedance variations that negatively impact the performance of a peak detector. In other examples, field reflecting objects, such as a user's head being close to a wall, along with similar objects located relatively close to an antenna, can also result in impedance variations that can have negative effects on a given peak detector's performance.

In an example, a peak detector can be configured to use a detected input signal voltage to determine a peak amplitude for an envelope. Alternatively, a power detector can be configured to rely on not just detection of an input signal voltage, but also on the resultant of processing one of the input signal current or impedance. In an example, while a power detector can require the implementation of a complex functional block, in applications where an impact impedance change is particularly disadvantageous (such as applications associated with movable devices like a headset), some advantages can justify any associated cost and/or complexity. In other examples, implementations of a peak detector alone in a fixed device, such as in a fixed wireless access application, can provide acceptable performance for many wireless communication systems.

FIG. 5A provides an illustration of another use environment for a dynamically mobile virtual reality (VR) device. In an example referring to FIG. 1A, a VR headset 352 is worn by a user in a wireless system incorporating one or more feedback devices, such as a display or a haptic sensor, and a base station, such as VR base station 354, using stationary spatially distributed RF terminals, such as the distributed RF terminals 350A-350N illustrated in FIG. 5A. In an example of implementation, each of the RF terminals 350A-350N can be coupled to a base station and/or controller over a wired local area network, a wireless local area network or a dedicated wired or wireless connection medium. In a specific example of implementation, each of the RF terminals 350A-350N, can be adapted to direct signal transmission toward the VR device of a user. In a related example, the wireless system can be configured to use two or more of RF terminals 350A-350N to provide antenna diversity for signals transmitted and received to and from VR headset 352, respectively.

In an example of implementation and operation, a user's inertial movements can be measured and transmitted to one or more spatially distributed RF terminals 350A-350N and processed for display and/or for interaction with an application executed by one or more processor modules associated with the VR headset 352. In an example, an application can be any of an exercise application, an augmented reality (AR) application, or any other conceivable interaction-based application. Additionally, in an example VR headset 352 can be adapted for use with additional devices associated with a user application, such as devices adapted as proxies for various sports implements or devices associated with a user's movement, each of which can also be tracked and utilized by an application to provide feedback and/or other application related uses.

FIG. 5B provides an illustration of a multi-user environment for a dynamically mobile virtual reality (VR) device. In an example referring to FIG. 5A, each VR headset 452-1, 452-2 and 452-3 in a multi-user environment can be adapted to transmit to one or more distributed RF terminals 450A-N. In an example, each user in the multi-user environment is provided with one or more substantially line-of-sight options to at least one RF terminal of the distributed RF terminals 450A-N.

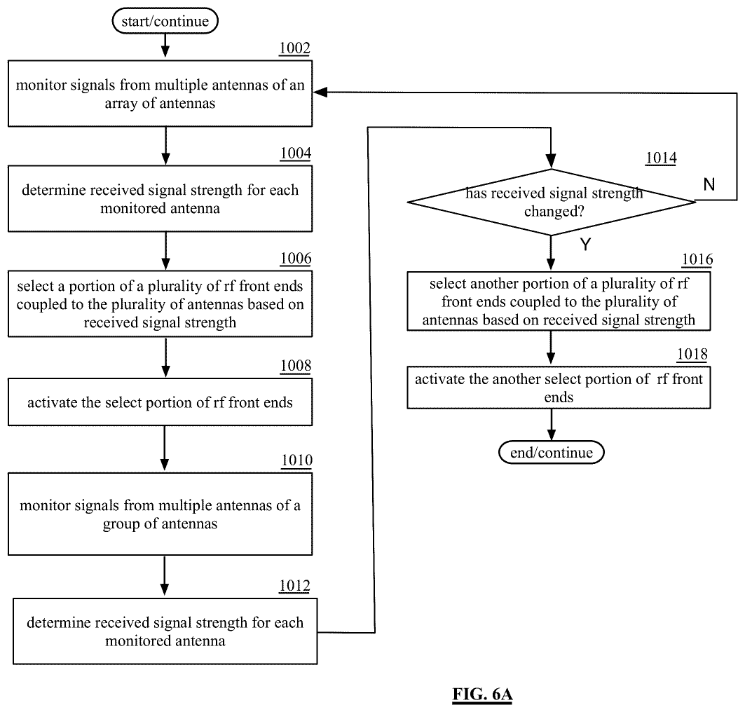

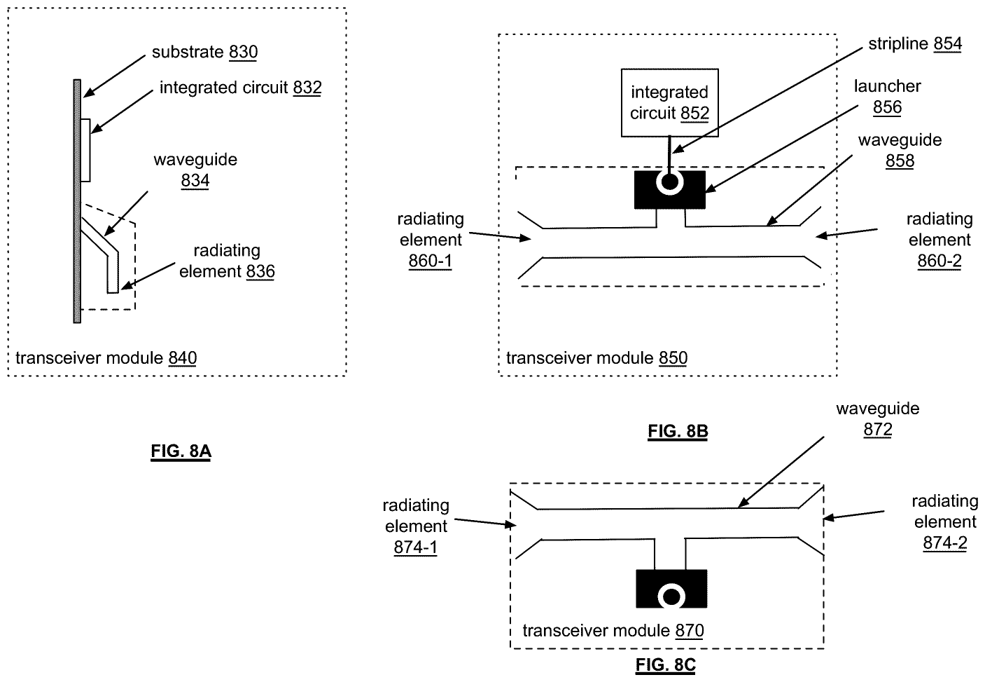

FIG. 6A is a logic diagram of an example method for implementing a wireless communication system for a dynamically mobile virtual reality (VR) device. The method begins at step 1002, with the wireless communication system monitoring signals from a plurality of antennas and/or radiating elements coupled to the wireless communication system. In an example of implementation, the plurality of antennas can be configured in an array, such as, for example, the antenna arrays illustrated with reference to FIGS. 2A-2E. In another example, for example referring to FIGS. 8A-13, a plurality of radiating elements associated with one or more hollow waveguides can be used for the monitoring function. In yet another example, a combination of antennas and radiating elements can be used to monitor the signals. In an example of implementation and operation, the monitoring can comprise receiving signals from the group of antennas and/or radiating elements simultaneously. In an alternate example of implementation, the monitoring can comprise receiving signals from the group of antennas and/or radiating elements seriatim, based on, for example, a timer and/or a duty cycle. In yet another example of implementation and operation, the monitoring function can be implemented according to a previously determined schedule, and in a related example, the monitoring function can be implemented according to a plurality of previously determined schedules, where the schedule is selected based on motion detection and/or other inertial measurements, either real-time or as predicted by historical activity and/or measurements.

The method continues at step 1004, by determining a received signal strength for each of the antennas and/or radiating elements. In a specific example referring to FIGS. 3B-3D, the received signal strength for each antenna being monitored can be determined using a received signal strength (RSS) detector and an associated radio front end (FE), such as the RSS detectors 722-1 to 722-6, referring to FIG. 3D and their equivalents in FIGS. 3A, 3B and 3C.

The method then continues at step 1006, with the wireless communication system selecting one or more antennas from the plurality of antennas and/or radiating elements based on the received signal strength. In an example of implementation and operation, the selection one or more can be executed using a digital signal processor or another device configured to analyze and trigger the selection. In an example, the monitored received signal strengths can be used to indicate a group of antennas of the plurality of antennas in an array that have a received signal above a predetermined signal strength threshold. In a related example, a comparison of received signal strengths from the group of antennas can reflect an antenna with a highest signal strength, along with weaker relative signal strengths for adjacent antennas in a given array, such that a center antenna can be determined, such as, for example, the center antenna 118, 118′ and referred to in FIGS. 2B-2E, respectively.

In an example of implementation and operation, the wireless communication system can be adapted to monitor signal strength associated with all or a portion of the available based on current applications being executed. For example, received signal strength (RSS) measurements can be scheduled more frequently for antennas in close proximity to a current center antenna, with RSS measurements schedule less frequently for antennas not determined to be in close proximity. In a related example, close proximity can be based on being adjacent to a current center antenna, or a larger subset of antennas in a given array. In an additional example, all antennas in an array can be scheduled for RSS measurement, regardless of proximity to the current central antenna, or when there is no current central antenna, at a predetermined time interval, in order to maintain precision and/or accuracy of the RSS determination for the system.

In another example of operation, a rate of received signal strength (RSS) measurement associated with antennas in an array can be determined based on a measurement of a rate of movement of the wireless communication system (such as, for example movement of a virtual reality system on a subject's head), where a faster measured or historical movement would result in a faster measurement rate and a slower measured or historical movement would result in a slower measurement rate. In an example, a rate of received signal strength (RSS) measurement associated with antennas in an array can be based on any of the factors discussed above, along with a predetermined and/or premeasured maximum rate beyond which a datarate for the wireless communication system will be adversely affected. For example, if the RSS measurement is made too frequently the wireless communication system can be unable to receive/transmit and/or process data from and to the system. In yet another example, a rate of received signal strength (RSS) measurement associated with antennas in an array can be reduced by including antennas in a group comprising antennas close to a current center antenna to contribute to the aggregate datarate of the system.

The method then continues at step 1008, with the wireless communication system activating radio frequency (RF) front ends associated with each antenna of the group of antennas for receiving and or transmitting wireless signals for the wireless communication system. In a specific example of operation and implementation, an RF front end associated with a selected center antenna, with or without the other antenna/RF front-end pairs in the group of antennas, can be selected to receive a signal from a base station and/or access point and then transmit an acknowledgement to the base station and/or access point, such that the base station and/or access point can direct the signal in the direction of the center antenna. In another example of implementation example, the wireless communication system can be configured to process received signal strength (RSS) on a frequent basis for currently active front ends (or for the front end associate with a center antenna, referring to FIGS. 28-2E) relative to nonactive front ends. In an example, when the RSS for one or more active front ends measures lower than a predetermined threshold, the one or more active associated front ends are shut off and one or more previously nonactive front-ends are activated. In an example, the one or more previously nonactive front-ends can be associated with antennas located opposite (on the opposite side of the array from the center antenna) the antennas associated with front ends being shut off direction.

In a specific example of implementation, a direction can be determined more or less accurately depending on a number of antennas associated with active front ends measuring with lower RSS (i.e. lower than a predetermined threshold) during a given time period. In an example, referring to FIG. 2B, if detector associated with antenna (4,3) only is indicating a signal lower than the threshold the wireless communication system can determine that antennas associated with a set of currently active front-ends need to be changed, such that antennas in an eastern direction (angle 0 deg) relative to the array can be activated, as illustrated in FIG. 2C. In another related example, if both detectors associated with antennas (4,3) and (5,4), respectively, measure with a weak signal (lower than the threshold), then the set of active front-ends need to move to front ends associated with antennas in a south-east direction (angle −45 deg) of the array, as illustrate in FIG. 2D.

In a specific example a set of front-ends can be substituted for an alternate set of front ends using any of the methodologies included herein. In an example referring to FIGS. 2B to 2E, if/when an array moves/rotates in an easterly direction, both detector (4,3) together with (5,2), (5,3) and (5,4) are lower than the threshold. In an example, it is known to move to an alternate set of front-ends in the easterly direction (centered at (7,3) instead of an adjacent set (centered at (6,3)). In another example, in the case of movement in a south-east direction, detectors (4,3) and (5,4) together with (5,3) would necessarily measure lower than the threshold. In a related example, alternate set centered at (7,1) can be selected for use instead of the adjacent set (centered at (6,2)).

In some examples of implementation, in order to avoid incorrect decisions, received signal strength (RSS) monitoring can be implemented such that inactivating a first set of radio front-ends and activating a second set of front-ends is completed before a next monitoring event occurs. In some examples, when RSS detectors are configured to switch on/off slow relative to the switching time for associated front-ends themselves, all or most RSS detectors in a wireless communication system can be adapted to remain powered continuously. In an example, power consumption for the RSS detectors can be configured to be relatively negligible, thus obviating a need to power down RSS detectors not associated to currently active front-ends.

At step 1010, the wireless communication system continues to monitor signals received at each of the multiple antennas in the array, and at step 1012, the received signal strength (RSS) for each of the antennas and/or radiating elements is determined in the manner described with reference to step 1004. At step 1014, the wireless communication system determines whether the RSS for one or more antennas of the antenna array (and/or radiating elements) has changed from the RSS determined at step 1004 and when the RSS has changed beyond a predetermined threshold, the wireless communication system selects another center antenna, along with adjacent antennas meeting the predetermined threshold and at step 1018 the wireless communication system activates RF front ends associated with the newly selected center antenna and adjacent antennas to receive and transmit wireless signals for the wireless communication system. In an example, the change in RSS can be due to a change in position of the dynamically mobile virtual reality (VR) device relative to the base station or access point, with the wireless communication system.

FIG. 6B is a logic diagram of an example method for implementing a wireless communication system for a plurality of dynamically mobile virtual reality (VR) devices. The method begins at step 1020, with a VR device (of a plurality of VR devices) monitoring signals received from each of a plurality of spatially distributed RF terminals. The method continues at step 1022, by determining a received signal strength for each of the monitored RF terminals.

The method then continues at step 1024, with the wireless communication system selecting one or more RF terminals of the plurality of RF terminals based on received signal strength. In an example of implementation and operation, the selection one or more can be executed using a digital signal processor or another device configured to analyze and trigger the selection. In an example, the monitored received signal strengths can be used to indicate an RF terminal from the available distributed RF terminals that has a received signal above a predetermined signal strength threshold. In a related example, a comparison of received signal strengths from the available distributed RF terminals with a highest signal strength. In a related specific example, when a plurality of VR headsets are attempting to connect to a base station, the base station can use location information for each VR headset of the plurality of VR headsets to manage and control the link for each VR headset. In another example, each VR headset can provide a relative location to the base station, with the base station adapted to determine an appropriate RF front end for linking to each VR headset of the plurality of VR headsets. In a specific alternative example, a base station can be adapted to match RF front ends with VR headsets without relying on RSS measurements, by determining a priori the best line-of-sight option for each VR headset based on known location, as well as other factors, such as anticipated changes in inertia for each VR headset of the plurality of headsets. In an additional related example, anticipated changes can be based on one or more of historical inertial measurements, changes dictated by an application being executed, or a trajectory derived from currently measured inertia changes.

The method then continues at step 1026, with the wireless communication system linking with the selected RF front end for receiving and or transmitting wireless signals between a base station and the VR headset. In a specific example of operation and implementation, a selected RF front end can be used to receive a signal from the base station and then transmit an acknowledgement to the base station, such that the base station can direct the signal in the direction of the VR headset with others of the distributed RF front ends linking with other VR headsets in the use environment.

At step 1028, the wireless communication system continues to monitor signals received from each of the RF terminals, and at step 1030, the received signal strength (RSS) for each of the RF front ends is determined in the manner described with reference to step 1022. At step 1032, the wireless communication system determines whether the RSS for the selected RF front end has changed from the RSS determined at step 1022 and when the RSS has changed beyond a predetermined threshold, the wireless communication system can negotiate with the base station to link with another RF front end. At step 1034, the wireless communication system determines to select one or more different RF terminals of the plurality of RF terminals, and at step 1036, the VR headset links with the one or more selected RF terminals. In an example, the change in RSS can be due to one or more of a change in position of the VR headset relative to the selected RF front end, another VR headset blocking or attenuating the signal to the VR headset to the selected RF front end or an anticipated change in RSS for the VR headset.

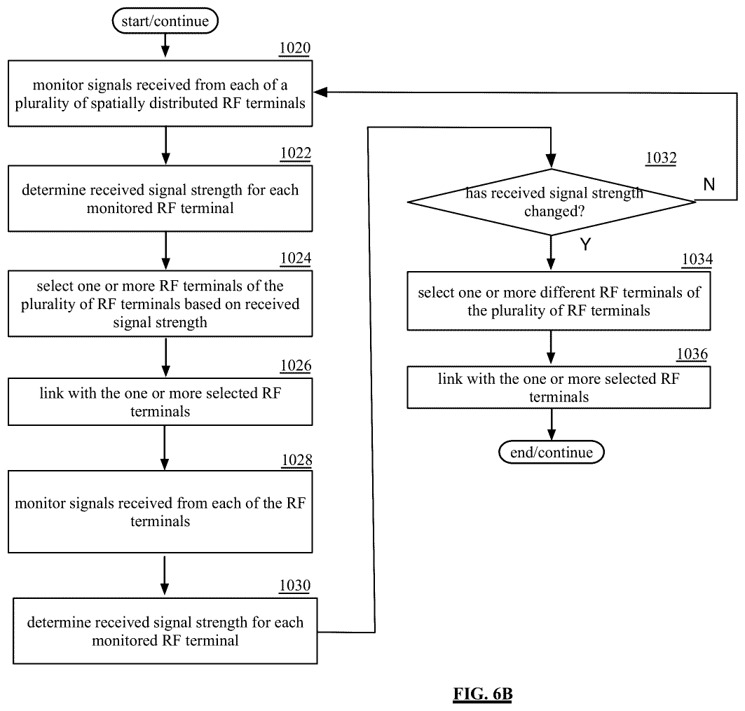

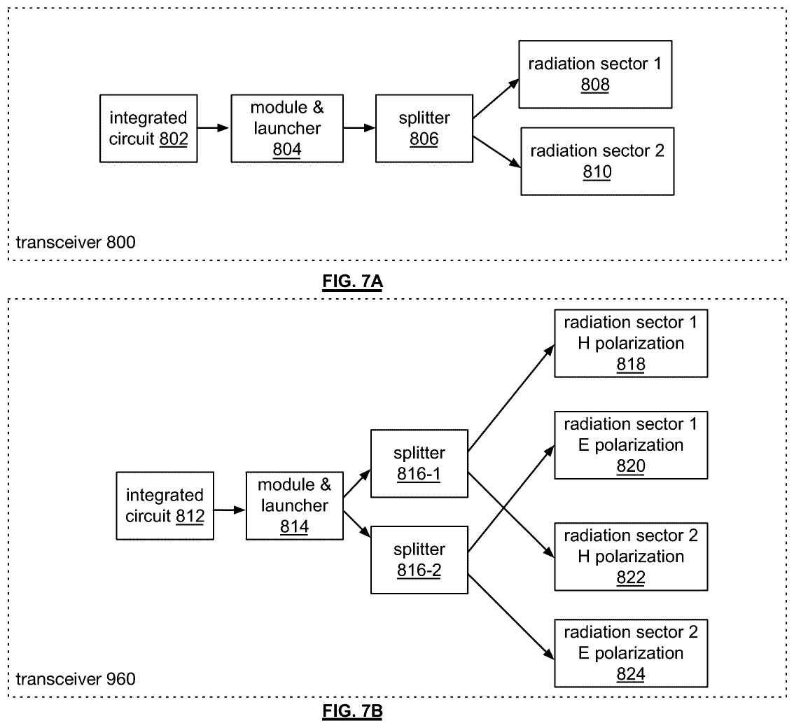

FIG. 7A provides a schematic block diagram of a wireless transceiver utilizing a waveguide. The waveguide structure is adapted to guide and transmit electromagnetic waves with minimal loss of energy by restricting energy transmission in substantially a single direction. In an example, the waveguide is characterized as a hollow tube or cavity, where the waveguide is a hollow metal tube or a metal duct of rectangular cross section that can act as a conduit for the propagation of electromagnetic waves. In another example, the waveguide can comprise a coaxial cable with an inner conductor surrounded by a concentric conducting shield, with the inner conductor separated from the conducting shield by a dielectric. In yet other examples, the waveguide comprises a flexible material with a hollow or substantially solid cross section.

In an example of implementation, waveguides have input and output ports where electromagnetic signals enter and exit the waveguide. In various examples, the input and output ports are configured to interface with other components, such as antennas or other waveguides. In a related example, waveguide can include walls that are designed to reflect and guide the electromagnetic waves along a desired path. In a specific example, the walls of a waveguide are adapted to be relatively smooth and may include specific geometrical shapes to support certain modes of wave propagation. In another specific example, waveguides include mode suppressors to, for example, reduce or eliminate unwanted modes of electromagnetic wave propagation. In yet another specific example, waveguides may be configured with bends and/or twists to direct electromagnetic waves in desired directions and/or around obstacles.

In an example of implementation and operation, transparent windows can incorporate a given waveguide to enable the transmission of electromagnetic waves across a boundary. In other examples, tuning screws and probes, or equivalents, can be used to adjust the impedance and standing waves inside a waveguide. In the various examples, specific design and components of a waveguide can vary depending on its intended use, frequency range, and other factors.

In the example of FIG. 7A, The transceiver 800 includes various components, including, integrated circuit 802 adapted to control transceiver functions and/or modulate signals received and transmitted via the transceiver. Other components include module & launcher 804, comprising an antenna and a waveguide launcher adapted to couple RF energy from the antenna into the waveguide. In an example, the module & launcher 804 can be provided as a single device adapted to receive an input from the integrated circuit 802 via a stripline antenna, or other element for providing an input to the antenna and waveguide launcher. In another example, module & launcher 804 can be provided on a module that includes integrated circuit 802, among other components. In an example of implementation, transceiver 800 can include a splitter 806 coupled to an output port of the module & launcher 804, where the splitter 806 is adapted to divide radio waves in two or multiple separate radio waves at output ports, such as radiating elements for radiation sector 1 808 and radiation sector 2 810 from FIG. 7A. In various examples, splitter 806 can be configured to include one or more of an input port for receiving RF transmission from a waveguide launcher, a taper section adapted to provide efficient separation of radio waves received at an input port and two or more output waveguides to guide radio waves to radiating elements.

In an example, each of radiation sector 1 808 and radiation sector 2 810 can be used to provide communication to or from a different RF source. In a specific example, where the output(s) of module & launcher 804 are split into multiple separate radio waves (beyond two) each of the radio waves can be adapted to accommodate a different user.

FIG. 7B provides a schematic block diagram of another wireless transceiver utilizing a waveguide structure. in accordance with the present invention; The transceiver 960 of FIG. 7B includes various components, including, integrated circuit 812 adapted to control transceiver functions and/or modulate signals received and transmitted via the transceiver. Other components include module & launcher 814 comprising an antenna and a waveguide launcher adapted to couple RF energy from the antenna into the waveguide. In an example, the module & launcher 814 can be provided as a single device adapted to receive an input from the integrated circuit 812 via a stripline antenna, or other element for providing an input to the antenna and waveguide launcher. In another example, module & launcher 814 can be provided on a module that includes integrated circuit 812, among other components. In an example of implementation, transceiver 906 can include a splitters 816-1 and 816-2 coupled to one or more output ports of module & launcher 814, where each of splitter 816-1 and splitter 816-2 is adapted to divide radio waves into two or multiple separate radio waves at output ports. In an example of implementation, spitters 816-1 and 816-2 are configured to provide radio waves with H polarization (H-plane) and E polarization (E-plane) respectively from the output(s) of module & launcher 814.

In an example, the E-plane comprises the electric field vector (E-aperture) in a direction of maximum radiation, where the E-plane is determinative of the polarization of the radio wave. In an example, for a vertically polarized antenna, the E-plane substantially coincides with a vertical/elevation plane. In an alternative example, pertaining to a horizontally polarized antenna, the E-Plane substantially coincides with the horizontal/azimuth plane, where the E-plane and H-plane are substantially 90 degrees apart.

In the example above, the H-plane comprises magnetic field vector (H-aperture) in the direction of maximum radiation. In an example, the H-plane lies at a right angle to the E-plane. In an example pertaining to a vertically polarized antenna, the H-plane usually coincides with the horizontal/azimuth plane. In an example pertaining to a horizontally polarized antenna, the H-plane substantially coincides with the vertical/elevation plane.

In an example, radio waves from each of radiation sector 1 H polarization 818, radiation sector 1 E polarization 820, as well as radiation sector 2 H polarization 822, radiation sector 2 E polarization 824 can be used to provide communication to or from a different RF source.

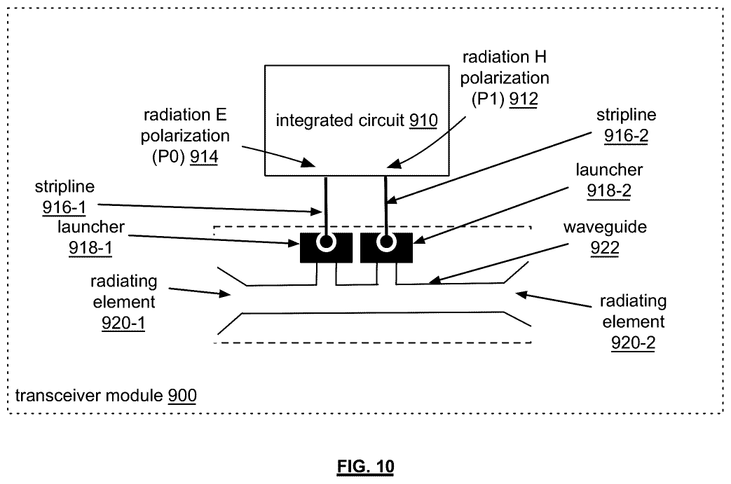

FIG. 8A provides a medial view diagram of a wireless transceiver utilizing a waveguide structure. The transceiver module 840 includes various components, including, integrated circuit 832 coupled to substrate 830, along with waveguide 834 that includes a radiating element 836. In an example, radiating element 836 can be configured in various structural forms, including, but not limited to, the examples of FIG. 10.

FIG. 8B provides top-down view diagram of a wireless transceiver utilizing a waveguide structure in a radio transceiver. The transceiver module 850 includes various components, including, integrated circuit 852 coupled via stripline 854 to launcher 856. In an example, waveguide 858 is coupled to radiating element 860-1 and radiating element 860-2. In an example, radiating elements 860-1 and 860-2 can be configured in various structural forms, including, but not limited to the examples of FIG. 10.

FIG. 8C provides medial view diagram of a wireless transceiver waveguide structure utilizing a waveguide. As illustrated, waveguide 872 of transceiver module 870 includes a straight section relative to the horizontal plane of transceiver module 870 that guides RF energy to each of radiating elements 874-1 and 874-2. In an example, radiating elements 874-1 and 874-2 can be configured in various structural forms, including, but not limited to the examples of FIG. 10.

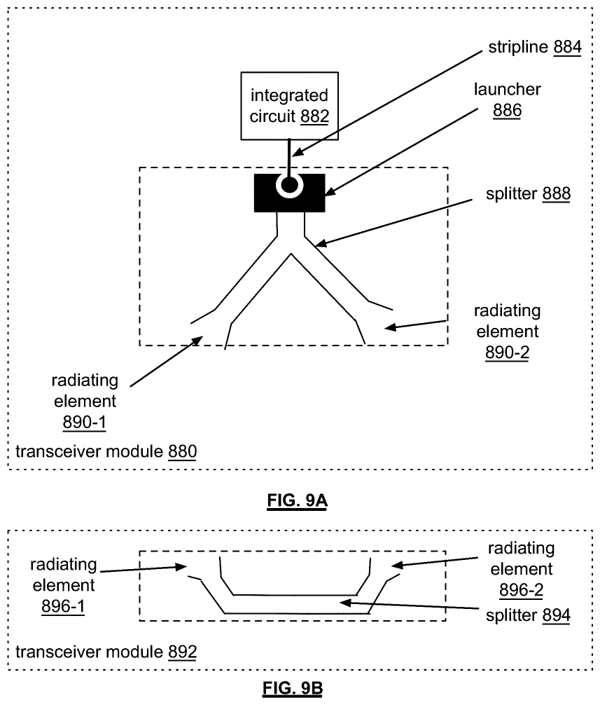

FIG. 9A provides top-down view diagram of a wireless transceiver utilizing a waveguide structure implemented with a splitter. The transceiver module 880 includes various components, including integrated circuit 882 coupled via stripline 884 to launcher 886. In an example, launcher 886 is coupled to splitter 888, which includes radiating element 890-1 and radiating element 890-2. Referring to FIG. 8A, in an example, radiating elements 890-1 and 890-2 can be configured in various structural forms, including, but not limited to the examples of FIG. 10.

FIG. 9B provides a medial view diagram of a wireless transceiver utilizing a waveguide structure implemented with a splitter. As illustrated, transceiver module 892 includes a straight waveguide section relative to the horizontal plane of transceiver module 892 configured to guide RF energy to each of radiating elements 896-1 and 896-2. Referring to FIGS. 8A-8C and 9B, in an example, radiating elements 896-1 and 896-2 can likewise be configured in various structural forms, including, but not limited to the examples of FIG. 10.

FIG. 10 provides a medial view diagram of a wireless transceiver utilizing a waveguide structure. The transceiver module 900 includes various components, including, integrated circuit 910 coupled via separate striplines to each of launcher 918-1 and launcher #918-2. In an example, integrated circuit 910 can be configured to provide an E-polarized RF energy (radiation E polarization (P0) 914 signal to stripline 916-1, which is adapted to provide RF energy representative of the signal to launcher 918-1. In the example, integrated circuit 910 can be configured to provide an H-polarized RF energy (radiation H polarization (P1 912) signal to stripline 916-2, which is adapted to provide RF energy representative of the signal to launcher 918-2. In an example, radiating element 920-1 and radiating element 920-2 can be configured in various structural forms. For example, radiating element 920-1 and radiating element 920-2 can each comprise a 3-port device (H-plane waveguide tee) adapted to divide or combine RF power in the waveguide(s) for transceiver module 900. In an example, when the axis of the waveguide tee is parallel to the flow of a magnetic field (H-plane) from a first port, it can function as a power divider/combiner for the waveguides. In the example, when two input signals are provided at a first and second input port, the output at a third port is in phase and additive, while an input signal provided at the third port is split into two equal parts that are in-phase at the first and second input ports.

In a related example, radiating element 920-1 and radiating element 920-2 can each comprise another 3-port device (E-plane waveguide tee), where the axis of a side arm is parallel to a collinear arm of the E-plane waveguide tee. In the example, an input signal at a first port results in outputs at each of a second and third output port that are substantially 180 degrees out of phase with each other. In the example, when an input signal is provided at the third input port, the output will be split across the first and second ports, where each of the first and second outputs are substantially 180 degrees out of phase with each other.

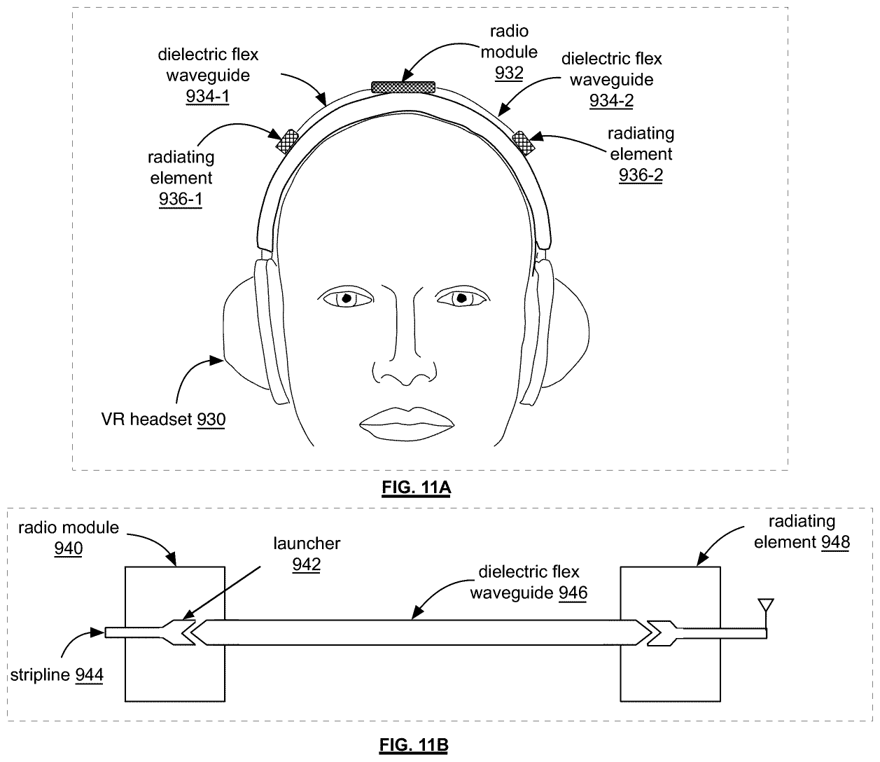

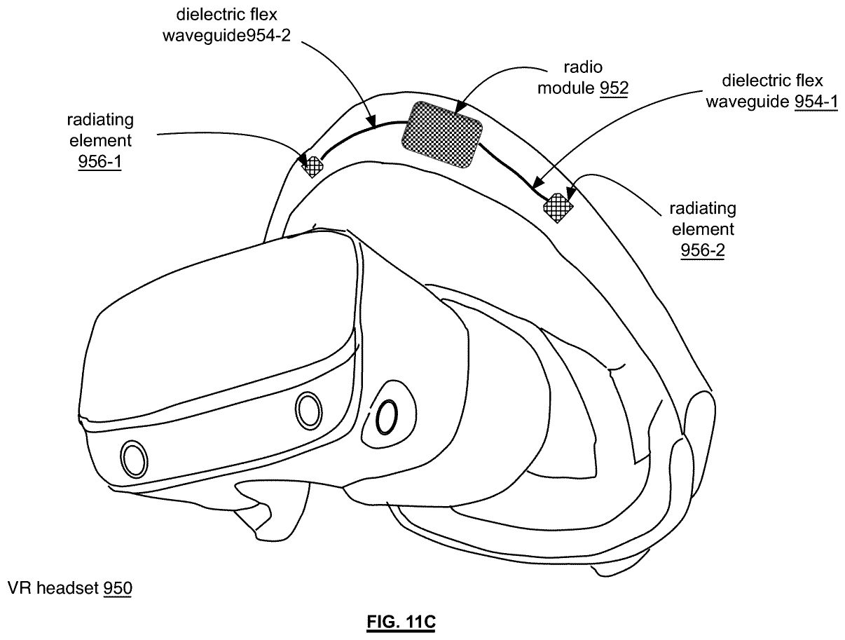

FIG. 11A is a medial view illustration of a dynamically mobile virtual reality (VR) device implemented using flexible waveguides. The VR device includes a wireless transceiver with one or more radio modules 932 coupled to a plurality of dielectric flex waveguides 934-1 and 934-2. In an example, dielectric flex waveguides 934-1 and 934-2 can be coupled to radiating elements, such as radiating elements 936-1 and 936-2, respectively. In an example, dielectric flex waveguides 934-1 and 934-2 are configured to follow the contours of VR headset 930 to minimize the profile of the wireless transceiver components while providing efficient line-of sight communication with one or more RF base stations.

In an example, the wireless system of the mobile virtual reality (VR) device illustrated in FIG. 11A can be implemented in a variety of dynamically mobile devices, including the mobile device illustrated in FIGS. 1E-1G. In an example, the wireless system can be configured as needed to use fewer radiating elements than the multi-element array illustrated in FIGS. 1E-1G, while maintaining a substantially line-of-sight connection to an associated access point.

FIG. 11B provides a medial view diagram of a dielectric flex waveguide structure. Radio module 940 is configured to provide a signal to a stripline antenna (stripline 944) adapted to provide RF energy representative of the signal to launcher 942. In an example, dielectric flex waveguide 946 is coupled at a first end to launcher 942 and to radiating element 948 at a second end.

FIG. 11C is a perspective view illustration of a dynamically mobile virtual reality (VR) device implemented using flexible waveguides. The VR device includes a wireless transceiver with one or more radio modules 940 coupled to a dielectric flex waveguide 946. In an example, dielectric flex waveguides dielectric flex waveguide 946 can be coupled to radiating elements, such as radiating element 948. In the example, dielectric flex waveguide 946 can be configured to follow the contours of VR headset 930 illustrated in FIG. 11A, to minimize the profile of the wireless transceiver components while providing efficient line-of sight communication with one or more RF base stations. In a related example, a wireless transceiver can be implemented within a headband or strap of a VR device with minimal effect on the profile of the VR device. In another related example, one or more radio module, such as radio module 940, can be implemented at various locations on a VR device to provide line-of-sight wireless communication with a stationary base station or access point, allowing for almost unlimited mobility for a VR device user in virtually any direction and/or rotational position.

As may be used herein, the terms “substantially” and “approximately” provide industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more examples have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more examples are used herein to illustrate one or more aspects, one or more features, one or more concepts, and/or one or more examples. A physical example of an apparatus, an article of manufacture, a machine, and/or of a process may include one or more of the aspects, features, concepts, examples, etc. described with reference to one or more of the examples discussed herein. Further, from figure to figure, the examples may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the examples. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form a solid-state memory, a hard drive memory, cloud memory, thumb drive, server memory, computing device memory, and/or other physical medium for storing digital information.

While particular combinations of various functions and features of the one or more examples have been expressly described herein, other combinations of these features and functions are likewise possible. The present disclosure is not limited by the particular examples disclosed herein and expressly incorporates these other combinations.

What is claimed is:

1. A radio transceiver comprises:
a plurality of radiating elements, wherein each radiating element of the plurality of radiating elements is spatially separated from every other radiating element of the plurality of radiating elements;
a plurality of radio frequency front-ends, wherein one or more radiating elements of the plurality of radiating elements is associated with a radio frequency front-end of the plurality radio frequency front-ends;
a plurality of received signal sensors, each received signal sensor of the plurality of received signal sensors coupled to one or more radiating elements, wherein each received signal sensor is adapted to output a signal representative of a received signal strength for the one or more radiating elements; and
one or more processors coupled to one or more received signal sensors of the plurality of received signal sensors, wherein the one or more processors are adapted to receive the signal representative of a received signal strength from each received signal sensor of the plurality of received signal sensors, wherein the one or more processors are further adapted to provide a control signal for changing a power mode for a set of radio frequency front-ends of the plurality radio frequency front-ends, wherein the control signal is based on the signal representative of a received signal strength from each received signal sensor coupled to the radio frequency front-end.

2. The radio transceiver of claim 1, wherein the power mode is one of a low-power mode or a high-power mode, wherein the low-power mode deactivates a radio frequency front-end and a high-power mode activates a radio frequency front-end.

3. The radio transceiver of claim 2, wherein the low-power mode is associated with a low bias for a power control element and a high-power mode is associated with a high bias for a power control element.

4. The radio transceiver of claim 1, wherein the control signal is further based on an external signal.

5. The radio transceiver of claim 4, wherein the external signal is a signal representative based at least one of:
a) a rate of motion;
b) a change in a rate of motion;
c) a predicted change in a rate of motion;
d) a direction of motion;
e) a change in a direction of motion;
f) a predicted change in a direction of motion;
g) an indication of relative signal strength;
h) a classification result of an artificial intelligence engine.

6. The radio transceiver of claim 1, wherein at least one radiating element associated with the set of radio frequency front-ends is spatially adjacent to at least one radiating element associated with another set of radio frequency front-ends of the plurality of radio frequency front-ends, wherein a radiating element of the set of radio frequency front ends is in a first power mode when a radiating element of the another set of radio frequency front-ends is in a different power mode, wherein the plurality of radiating elements comprise an array of radiating elements.

7. The radio transceiver of claim 1, wherein at least one radiating element associated with the set of radio frequency front-ends is alternate to at least one radiating element associated with another set of radio frequency front-ends of the plurality of radiating elements, wherein a radio frequency front-end of the set of radio frequency front-ends is in a first power mode when a radio frequency front-end of the of the another set of radio frequency front-ends is in a different power mode, wherein the plurality of radiating elements comprise an array of radiating elements.

8. The radio transceiver of claim 1, wherein the set of radio frequency front-ends does not exceed one half of the set of radio frequency front ends in the plurality of set of radio frequency front-ends.

9. The radio transceiver of claim 1, wherein each radio frequency front end includes at least one of a power amplifier, a low noise amplifier and a phase shifter.

10. A method for one or more modules of one or more processors of a wireless communication system, the method comprises:
monitoring signals from each radiating element of a group of radiating elements to generate a plurality of signals, wherein a signal of the plurality of signals is representative of received signal strength for a radiating element of the group of radiating elements, wherein each radiating element of the group of radiating elements is associated with a radio frequency front end of a plurality of radio frequency front-ends;
determining, based on the monitoring, a relative received signal strength for each radiating element of the group of radiating elements;
in response to the relative received signal strength for a radiating element of the group of radiating elements, changing a radio frequency front-end of a first set of radio frequency front-ends of the plurality of radio frequency front-ends to a low-power mode and changing a radio frequency front end of a second set of radio frequency front ends of the plurality of radio frequency front ends to a high-power mode.

11. The method of claim 10, wherein the monitoring is based on a duty-cycle, wherein a duty-cycle is a fraction of time in a time window during which monitoring is executed.

12. The method of claim 10, wherein changing the radio frequency front-end of a first set of radio frequency front-ends of the plurality of radio frequency front-ends to a low-power mode and changing a radio frequency front-end of a second set of radio frequency front-ends of the plurality of radio frequency front-ends to a high-power mode is further based on an external signal.

13. The method of claim 12, wherein the external signal is a signal representative based at least one of:
i) a rate of motion;
j) a change in a rate of motion;
k) a predicted change in a rate of motion;
l) a direction of motion;
m) a change in a direction of motion;
n) a predicted change in a direction of motion;
o) an indication of relative signal strength;
p) a classification result of an artificial intelligence engine.

14. The method of claim 10, wherein at least one radiating element associated with the set of radio frequency front-ends is spatially adjacent to at least one radiating element associated with another set of radio frequency front-ends of the plurality of radio frequency front ends, wherein a radiating element of the set of radio frequency front-ends is in a low-power mode when a radiating element of the another set of radio frequency front ends is in a high-power mode, wherein the plurality of radiating elements comprise an array of radiating elements.

15. The method of claim 10, wherein at least one radiating element associated with the first set of radio frequency front-ends is an alternate to at least one radiating element associated with the second set of radio frequency front-ends, wherein a radio frequency front-end of the first set of radio frequency front-ends is in a first power mode when a radio frequency front-end of the of the second set of radio frequency front-ends is in a high power mode, wherein the plurality of radiating elements comprise an array of radiating elements.

16. The method of claim 10, wherein each radio frequency front-end includes at least one of a power amplifier, a low noise amplifier and a phase shifter.

17. The method of claim 10, wherein the low-power mode is associated with a low bias for a power control element and the high-power mode is associated with a high bias for a power control element.

18. A wireless communication system comprises:
a plurality of wireless terminals, wherein each wireless terminal of the plurality of wireless terminals is spatially separated from every other wireless terminals of the plurality of wireless terminals;
a plurality of radio frequency front ends, wherein a radio frequency front end of the plurality of radio frequency front ends is coupled to a radio frequency front end of the plurality radio frequency front ends, wherein each radio frequency front end includes;
a plurality of received signal sensors, wherein a received signal sensor of the plurality of received signal sensors is coupled to one or more radiating elements and a radio frequency front end of the plurality of radio frequency front ends, wherein each received signal sensor is adapted to output a signal representative of a received signal strength for the one or more radiating elements;
one or more processors coupled to one or more received signal sensors of the plurality of received signal sensors, wherein the one or more processors are adapted to receive the signal representative of a received signal strength from each received signal sensor of the plurality of received signal sensors, wherein the one or more processors are further adapted to provide a control signal for activating each radio frequency front end of the plurality of radio frequency front ends, wherein the control signal is based on the signal representative of a received signal strength from a received signal sensor coupled to the radio frequency front end.

19. The wireless communication system of claim 18, wherein each radio frequency front end includes at least one of a power amplifier, a low noise amplifier and a phase shifter.

20. The wireless communication system of claim 18, further comprising baseband processing device, wherein the baseband processing device is configured to communicate with a wide access network.

21. The wireless communication system of claim 20, wherein a wireless terminal of the plurality of wireless terminals are adapted to communicate with another wireless terminal of the plurality of wireless terminals using a mesh network.

22. A radio transceiver comprises:
a plurality of radiating elements coupled to a substrate, each radiating element of the plurality of radiating elements defining a radiation sector of a plurality of radiation sectors;
a plurality of waveguides coupled to the substrate, wherein a waveguide of the plurality of waveguides is coupled at a first input/output port to one or more radiating elements of the plurality of radiating elements, wherein the waveguide is adapted to follow a shape of the substrate; and
a radio module coupled to the substrate, the radio module adapted provide an input and an output to a waveguide for one or more radiation sectors of the plurality of radiation sectors, wherein the radio module is further adapted to facilitate communication with a common wireless access point through one or more radiating elements of the plurality of radiating elements, wherein the radio transceiver is adapted for use by a mobile user.

23. The radio transceiver of claim 22, further comprising one or more splitter/combiners, wherein a splitter/combiner is coupled to two or more waveguides of the plurality of waveguides at a second input/output port of the two or more waveguides, wherein the splitter/combiner is further configured to combine and distribute one or more signals to and from the two or more waveguides.

24. The radio transceiver of claim 22, wherein at least one waveguide of the plurality of waveguides is a flexible waveguide.

25. The radio transceiver of claim 22, wherein the radio transceiver is implemented in a virtual reality headset.

26. The radio transceiver of claim 22, wherein the radio transceiver is adapted for use in a wireless local area network.

27. The radio transceiver of claim 26, wherein the wireless local area network is configured to operate in compliance with at least one IEEE 802.11 specification.

28. The radio transceiver of claim 22, wherein at least one radiating element of the plurality of radiating elements comprises at least one of a stripline antenna or an aperture antenna.

29. The radio transceiver of claim 22, wherein each radiation sector defines a different radiation sector from any other radiation sector of the of a plurality of radiation sectors.

30. The radio transceiver of claim 22, wherein each radiation sector is configured for a plurality of polarization orientations of emission and a plurality of polarization orientations of reception for the radiation sector, the plurality of polarization orientations including at least one of a combination of H and E or circular orientations.

31. The radio transceiver of claim 22, wherein the radio transceiver is further adapted for continuous motion when in communication with the common wireless access point.
